(19) United States
(12) Patent Application Publication
(10) Pub. No.: US 2026/0233596 A1
(43) Pub. Date: Aug. 13, 2026

(54) INTEGRATED CHASSIS ASSEMBLY FOR ELECTRIC VEHICLE

(71) Applicant: HORWIN INC., Changzhou (CN)

(72) Inventors: Rui CHEN, Changzhou (CN); Wei ZHOU, Changzhou (CN); Panhua ZENG, Changzhou (CN); Shipu WANG, Changzhou (CN)

(73) Assignee: HORWIN INC., Changzhou (CN)

(21) Appl. No.: 19/522,565

(22) PCT Filed: Dec. 12, 2023
(86) PCT No.: PCT/CN2023/138077

§ 371 Date: Mar. 24, 2026

(30) Foreign Application Priority Data
Apr. 21, 2023 (CN) 202320934085.5

(51) Int. Cl. B60K 1/04; B60K 1/00; B60L 15/20; H01M 10/46; H01M 10/613; H01M 10/625; H01M 10/6551; H01M 10/6556; H01M 10/6568; H01M 50/224; H01M 50/249

(52) U.S. Cl. CPC B60K 1/04; B60L 15/20; H01M 10/46; H01M 10/613; H01M 10/625; H01M 10/6551; H01M 10/6556; H01M 10/6568; H01M 50/224; H01M 50/249; B60K 2001/005; H01M 2220/20

(57) ABSTRACT

An integrated chassis assembly for the electric vehicle includes a front vehicle frame, a battery pack housing, and a rear vehicle frame, where the front vehicle frame and the rear vehicle frame are respectively arranged at the front side and the rear side of the battery pack housing; a battery pack is arranged in the battery pack housing; a whole-vehicle controller is arranged on the battery pack housing; a charging seat is arranged on a side surface of the rear vehicle frame; and a motor-electric control integrated machine is arranged on the rear side surface of the battery pack housing. The effects that the integrated chassis may be assembled without cables and water pipes, neat and simple in whole appearance, rapid to install, and convenient for mass production and fully-automatic assembly, and may also be rapidly assembled into different vehicle models.

### TECHNICAL FIELD

The present disclosure relates to the technical field of chassis for electric vehicles, and especially relates to an integrated chassis assembly for an electric vehicle.

### BACKGROUND

Chassis for electric vehicles in the market are complex in structure, and cables and water pipes are chaotic in distribution and arrangement, so that quite inconvenient installation is caused, and rapid mass production and fully-automatic assembly cannot be realized in a production process; and moreover, due to the chaotic components and combination manners, during design for new vehicle models, it is often necessary to completely overturn all component positions and design solutions, so that an extremely-low development speed for new products is caused.

### SUMMARY

The purpose of the present disclosure is to provide an integrated chassis assembly for an electric vehicle with regard to the defects existing in the prior art, and the effects that the integrated chassis may be assembled without cables and water pipes, neat and simple in whole appearance, rapid to install, and convenient for mass production and fully-automatic assembly, and may also be rapidly assembled into different vehicle models, so that the design workload for new vehicle models is greatly reduced, and the development speed for new products is increased, are achieved.

In order to achieve the above purpose, the technical solution adopted by the present disclosure is that:
a front vehicle frame, a battery pack housing, and a rear vehicle frame are included; the front vehicle frame and the rear vehicle frame are respectively arranged at the front side and the rear side of the battery pack housing; a battery pack is arranged in the battery pack housing; a whole-vehicle controller is arranged on the battery pack housing; a charging seat is arranged on a side surface of the rear vehicle frame; a motor-electric control integrated machine is arranged on the rear side surface of the battery pack housing; the whole-vehicle controller is provided with a first electric plug, and a first electric socket cooperated with the first electric plug is arranged on the battery pack housing; the whole-vehicle controller is in circuit connection with the battery pack through the cooperation of the first electric plug and the first electric socket; a heat dissipation assembly is arranged on the front side surface of the battery pack housing, the heat dissipation assembly is connected with an internal water passage in the battery pack housing, and the internal water passage passes through the battery pack; the motor-electric control integrated machine is provided with a second electric plug and a water pipe connector, a second electric socket cooperated with the second electric plug is further arranged on the rear side surface of the battery pack housing, the motor-electric control integrated machine is in circuit connection with the battery pack and the whole-vehicle controller through the cooperation of the second electric plug and the second electric socket, the water pipe connector is connected with the internal water passage in the battery pack housing, and the internal water passage passes through the motor-electric control integrated machine; and the battery pack, the whole-vehicle controller and the motor-electric control integrated machine are in circuit connection.

Further, the charging seat is arranged on the side surface of the rear vehicle frame, and the charging seat is in circuit connection with the battery pack.

Further, a cushion support is further arranged on the rear vehicle frame, and the cushion support and the rear vehicle frame are locked and fixed through screws.

Further, an antilock brake system (ABS) controller is arranged on the front vehicle frame, the ABS controller is installed on the front vehicle frame through a support, and the ABS controller is in circuit connection with the battery pack, the whole-vehicle controller, the charging seat and the motor-electric control integrated machine.

Further, a pedal support is further arranged, and the pedal support is installed at the position of a boss below the battery pack housing.

Further, a side bracing is further arranged, the side bracing is locked to the side surface of the battery pack housing through screws, and a power-off switch is further integrated to the inner side of the side bracing; and the power-off switch is in circuit connection with the battery pack, the whole-vehicle controller, the charging seat, and the motor-electric control integrated machine.

Further, a heat dissipater, a refrigerator, and an electronic water pump are arranged in the heat dissipation assembly.

Further, the whole-vehicle controller, the charging seat, and the motor-electric control integrated machine are all locked and fixed to the battery pack housing through screws.

Further, the front vehicle frame, the battery pack housing, and the rear vehicle frame are made of lightweight aluminum alloy materials, and are formed in a manner of die casting and through adopting a liquid forging technology.

Through the technical solution of the present disclosure, the following technical effects may be realized:
through the structure that a front vehicle frame, a battery pack housing, and a rear vehicle frame are included, the front vehicle frame and the rear vehicle frame are respectively arranged at the front side and the rear side of the battery pack housing, a battery pack is arranged in the battery pack housing, a whole-vehicle controller is arranged on the battery pack housing, a charging seat is arranged on a side surface of the rear vehicle frame, a motor-electric control integrated machine is arranged on the rear side surface of the battery pack housing, the whole-vehicle controller is provided with a first electric plug, a first electric socket cooperated with the first electric plug is arranged on the battery pack housing, the whole-vehicle controller is in circuit connection with the battery pack through the cooperation of the first electric plug and the first electric socket, a heat dissipation assembly is arranged on the front side surface of the battery pack housing, the heat dissipation assembly is connected with an internal water passage in the battery pack housing, the internal water passage passes through the battery pack, the motor-electric control integrated machine is provided with a second electric plug and a water pipe connector, a second electric socket cooperated with the second electric plug is further arranged on the rear side surface of the battery pack housing, the motor-electric control integrated machine is in circuit connection with the battery pack and the whole-vehicle controller through the cooperation of the second electric plug and the second electric socket, the water pipe connector is connected with the internal water passage in the battery pack housing, and the internal water passage passes through the motor-electric control integrated machine, and the battery pack, the whole-vehicle controller and the motor-electric control integrated machine are in circuit connection, the effects that the integrated chassis may be assembled without cables and water pipes, neat and simple in whole appearance, rapid to install, and convenient for mass production and fully-automatic assembly, and may also be rapidly assembled into different vehicle models, so that the design workload for new vehicle models is greatly reduced, and the development speed for new products is increased, are achieved.

### BRIEF DESCRIPTION OF DRAWINGS

In order to describe the technical solutions in the examples of the present disclosure or in the prior art more clearly, the drawings that need to be used in the descriptions for the examples or the prior art are briefly introduced below, and apparently, the drawings in the descriptions below are merely some examples recorded in the present disclosure, and those of ordinary skill in the art may also acquire other drawings according to these drawings without any creative efforts.

FIG. 1 is a schematic diagram of an integrated chassis assembly for an electric vehicle in examples of the present disclosure;

FIG. 2 is an explosive view of FIG. 1 in the examples of the present disclosure;

FIG. 3 is a main view of the integrated chassis assembly for the electric vehicle in the examples of the present disclosure;

FIG. 4 is an explosive view of FIG. 3 in the examples of the present disclosure;

FIG. 5 is a schematic diagram of a motor-electric control integrated machine in the examples of the present disclosure; and

FIG. 6 is a schematic diagram of a heat dissipation assembly in the examples of the present disclosure.

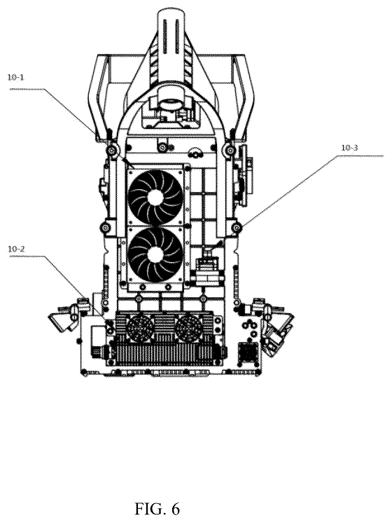

Marks of the drawings: front vehicle frame 1, battery pack housing 2, first electric socket 2-1, second electric socket 2-2, internal water passage 2-3, rear vehicle frame 3, battery pack 4, ABS controller 5, whole-vehicle controller 6, first electric plug 6-1, power-off switch 7, charging seat 8, motor-electric control integrated machine 9, second electric plug 9-2, water pipe connector 9-3, heat dissipation assembly 10, heat dissipater 10-1, refrigerator 10-2, electronic water pump 10-3, pedal support 11, side bracing 12, and cushion support 13.

### DETAILED DESCRIPTION OF THE EMBODIMENTS

The technical solutions in the examples of the present disclosure will be clearly and completely described below in conjunction with the drawings in the examples of the present utility, and apparently, the described examples are merely a part of the examples of the present disclosure, rather than all of them.

In the description for the present disclosure, it needs to be noted that, the orientations or position relationships indicated by “center”, “upper”, “lower”, “left”, “right”, “vertical”, “horizontal”, “inside”, “outside”, etc. are based on the orientations or position relationships shown in the drawings, and it is merely for the convenience of describing the present disclosure and simplifying the description, rather than indicating or implying that the apparatus or element referred to must have a specific orientation, and must be constructed and operated in a specific orientation, therefore, it cannot be understood as a limitation on the present disclosure.

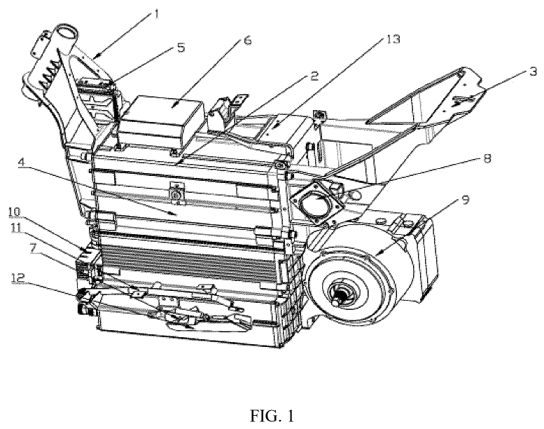

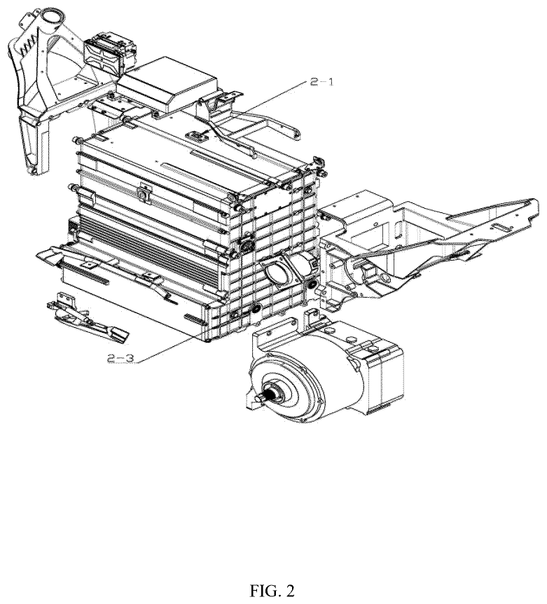

An integrated chassis assembly for an electric vehicle, as shown in FIG. 1 and FIG. 2, includes a front vehicle frame 1, a battery pack housing 2, and a rear vehicle frame 3, where the front vehicle frame 1 and the rear vehicle frame 3 are respectively arranged at the front side and the rear side of the battery pack housing 2; a battery pack 4 is arranged in the battery pack housing 2; a whole-vehicle controller 6 is arranged on the battery pack housing 2; a charging seat 8 is arranged on a side surface of the rear vehicle frame 3; a motor-electric control integrated machine 9 is arranged on the rear side surface of the battery pack housing 2; the whole-vehicle controller 6 is provided with a first electric plug 6-1, and a first electric socket 2-1 cooperated with the first electric plug 6-1 is arranged on the battery pack housing 2; the whole-vehicle controller 6 is in circuit connection with the battery pack 4 through the cooperation of the first electric plug 6-1 and the first electric socket 2-1; a heat dissipation assembly 10 is arranged on the front side surface of the battery pack housing 2, the heat dissipation assembly 10 is connected with an internal water passage 2-3 in the battery pack housing 2, and the internal water passage 2-3 passes through the battery pack 4; the motor-electric control integrated machine 9 is provided with a second electric plug 9-2 and a water pipe connector 9-3, a second electric socket 2-2 cooperated with the second electric plug 9-2 is further arranged on the rear side surface of the battery pack housing 2, the motor-electric control integrated machine 9 is in circuit connection with the battery pack 4 and the whole-vehicle controller 6 through the cooperation of the second electric plug 9-2 and the second electric socket 2-2, the water pipe connector 9-3 is connected with the internal water passage 2-3 in the battery pack housing 2, and the internal water passage 2-3 passes through the motor-electric control integrated machine 9; and the battery pack 4, the whole-vehicle controller 6 and the motor-electric control integrated machine 9 are in circuit connection.

Specifically, through the structure that a front vehicle frame 1, a battery pack housing 2, and a rear vehicle frame 3 are included, and the front vehicle frame 1 and the rear vehicle frame 3 are respectively arranged at the front side and the rear side of the battery pack housing 2, an integrated chassis framework is formed through the front vehicle frame 1, the battery pack housing 2, and the rear vehicle frame 3, and bears the load of the whole vehicle and all external forces in a movement process by serving as a main body structure of the vehicle. Then through the structure that a battery pack 4 is arranged in the battery pack housing 2, a whole-vehicle controller 6 is arranged on the battery pack housing 2, a charging seat 8 is arranged on a side surface of the rear vehicle frame 3, and a motor-electric control integrated machine 9 is arranged on the rear side surface of the battery pack housing 2, an integrated core platform for the vehicle is composed in the case of integrating the core electromechanical assemblies. The whole-vehicle controller 6 is provided with a first electric plug 6-1, and a first electric socket 2-1 cooperated with the first electric plug 6-1 is arranged on the battery pack housing 2, and the whole-vehicle controller 6 is in circuit connection with the battery pack 4 through the cooperation of the first electric plug 6-1 and the first electric socket 2-1, so that no need of a cable for the connection between the whole-vehicle controller 6 and the battery pack 4 is achieved. Through the structure that a heat dissipation assembly 10 is arranged on the front side surface of the battery pack housing 2, the heat dissipation assembly 10 is connected with an internal water passage 2-3 in the battery pack housing 2, and the internal water passage passes through the battery pack 4, the heat dissipation assembly 10 is arranged at the windward side of the vehicle, so that the problem of heat dissipation in areas with heat accumulation and difficulty in exchanging heat with the outside, is solved, and meanwhile, through the unified heat dissipation, the system complexity of a plurality of water cooling loops is reduced, and assemblies such as water pipes and joints are simplified; then through the structure that the motor-electric control integrated machine 9 is provided with a second electric plug 9-2 and a water pipe connector 9-3, a second electric socket 2-2 cooperated with the second electric plug 9-2 is further arranged on the rear side surface of the battery pack housing 2, the motor-electric control integrated machine 9 is in circuit connection with the battery pack 4 and the whole-vehicle controller 6 through the cooperation of the second electric plug 9-2 and the second electric socket 2-2, the water pipe connector 9-3 is connected with the internal water passage 2-3 in the battery pack housing 2, and the internal water passage 2-3 passes through the motor-electric control integrated machine 9, no need of a cable for the connection between the motor-electric control integrated machine 9 and the battery pack 4 is achieved, and no need of a water pipe for the connection between the motor-electric control integrated machine 9 and the heat dissipation assembly 10 is achieved; and moreover, through the structure that the battery pack 4, the whole-vehicle controller 6, charging seat 8 and the motor-electric control integrated machine 9 are in circuit connection, the key electrical assemblies such as the battery pack 4, the motor-electric control integrated machine 9 and the whole-vehicle controller 6, of the whole vehicle, are integrated to the integrated chassis to compose a highly-integrated mechanical-electrical integrated chassis assembly, so that the integrated chassis assembly is assembled without the cables and the water pipes, neat and simple in whole appearance, and rapid to install, and the connection manners conform to the current habits of assembling mechanical arms in unmanned factories, so that a solid foundation is provided for realizing fully-automatic assembly in subsequent mass production, and the integrated chassis assembly serves as a core platform for the vehicle, and may be rapidly assembled into different vehicle models according to different product plans and only through adjusting the other components such as a front shock absorber, a rear shock absorber, front tires, rear tires, and external plastic parts, so that the design workload for new vehicle models is greatly reduced, and the development speed for new products is increased.

As a preference of the above example, as shown in FIG. 1, a charging seat 8 is arranged on a side surface of the rear vehicle frame 3, and the charging seat 8 is in circuit connection with the battery pack 4.

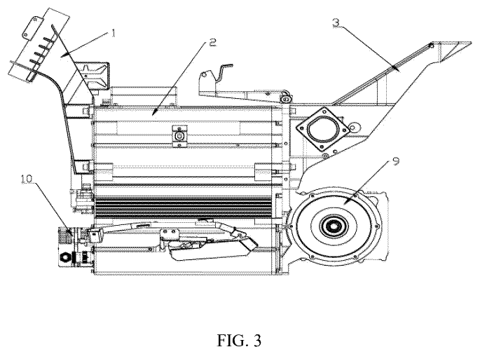

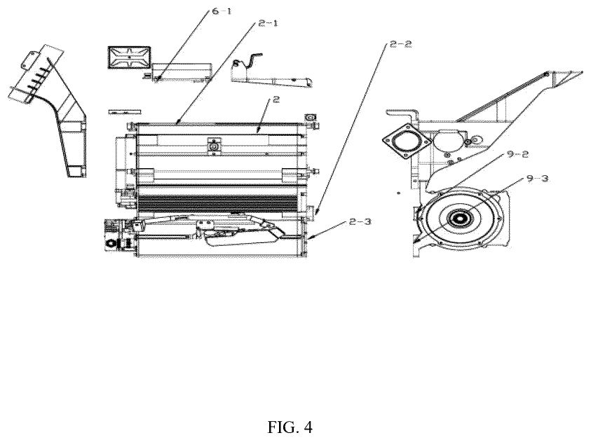

As a preference of the above example, as shown in FIG. 3 and FIG. 4, a cushion support 13 is further arranged on the rear vehicle frame 3, and the cushion support 13 and the rear vehicle frame 3 are locked and fixed through screws.

As a preference of the above example, as shown in FIG. 3 and FIG. 4, an ABS controller 5 is arranged on the front vehicle frame 1, the ABS controller 5 is installed on the front vehicle frame 1 through a support, and the ABS controller 5 is in circuit connection with the battery pack 4, the whole-vehicle controller 6, the charging seat 8 and the motor-electric control integrated machine 9.

As a preference of the above example, as shown in FIG. 3 and FIG. 4, a pedal support 11 is further arranged, and the pedal support 11 is installed at the position of a boss below the battery pack housing 2.

Specifically, through the structure that a cushion support 13 is further arranged on the rear vehicle frame 3, the cushion support 13 and the rear vehicle frame 3 are locked and fixed through screws, an ABS controller 5 is arranged on the front vehicle frame 1, the ABS controller 5 is installed on the front vehicle frame 1 through a support, the ABS controller 5 is in circuit connection with the battery pack 4, the whole-vehicle controller 6, the charging seat 8 and the motor-electric control integrated machine 9, a pedal support 11 is further arranged, and the pedal support 11 is installed at the position of a boss below the battery pack housing 2, the seat cushion supports 13 provides adjustment supporting for cushions of the vehicle, the pedal support 11 provides adjustment supporting for a pedal of the vehicle, and the ABS controller 5 completes ABS control for the vehicle.

As a preference of the above example, as shown in FIG. 3 and FIG. 4, a side bracing 12 is further arranged, the side bracing 12 is locked to the side surface of the battery pack housing 2 through screws, and a power-off switch 7 is further integrated to the inner side of the side bracing 12; and the power-off switch 7 is in circuit connection with the battery pack 4, the whole-vehicle controller 6, the charging seat 8, and the motor-electric control integrated machine 9.

Specifically, through the structure that the side bracing 12 is locked to the side surface of the battery pack housing 2 through screws, a power-off switch 7 is further integrated to the inner side of the side bracing 12, and the power-off switch 7 is in circuit connection with the battery pack 4, the whole-vehicle controller 6, the charging seat 8, and the motor-electric control integrated machine 9, the side bracing 12 provides a supporting function for the vehicle, and the power-off switch 7 at the inner side of the side bracing 12 provides power-off safety supporting for the whole vehicle.

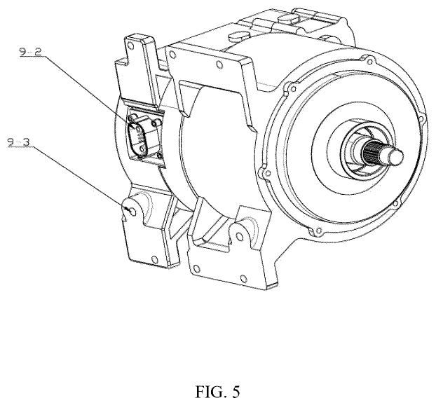

As a preference of the above example, as shown in FIG. 5, a heat dissipater 10-1, a refrigerator 10-2, and an electronic water pump 10-3 are arranged in the heat dissipation assembly 10.

Specifically, through the structure that a heat dissipater 10-1, a refrigerator 10-2, and an electronic water pump 10-3 are arranged in the heat dissipation assembly 10, all heat generated by the battery pack 4, the motor-electric control integrated machine 9, and the other electrical components during working is concentratedly conveyed to the front end through the internal water passage 2-3, and then flows back to the interior through the refrigerator 10-2 and the heat dissipater 10-1, and the electronic water pump 10-3 provides power for a whole heat dissipation system.

As a preference of the above example, as shown in FIG. 1, the whole-vehicle controller 6, the charging seat 8, and the motor-electric control integrated machine 9 are all locked and fixed to the battery pack housing 2 through screws.

As a preference of the above example, as shown in FIG. 1, the front vehicle frame 1, the battery pack housing 2, and the rear vehicle frame 3 are made of lightweight aluminum alloy materials, and are formed in a manner of die casting and through adopting a liquid forging technology.

Specifically, through the structure that the front vehicle frame 1, the battery pack housing 2, and the rear vehicle frame 3 are made of lightweight aluminum alloy materials, and are formed in a manner of die casting and through adopting a liquid forging technology, and through the characteristics of high strength, high plasticity, and high fatigue resistance of the aluminum alloy materials, the integrated chassis assembly are greatly reduced in dead weight compared to a traditional steel vehicle frame, beautiful in appearance, and capable of being directly taken as a decorative surface for the appearance of the vehicle after different surface treatments, so that the plastic parts of the vehicle are reduced, and the number of the assemblies of the vehicle is reduced.

The above shows and describes the basic principles, main features, and advantages of the present disclosure. Those skilled in the art should understand that, the present disclosure is not limited by the above examples, the descriptions in the above examples and the specification are merely the principle for explaining the present disclosure, there will be various modifications and improvements in the present disclosure, without departing from the spirit and scope of the present disclosure, and these modifications and improvements all fall within the scope requires protection, of the present disclosure. The scope requires protection, of the present disclosure is defined by the attached claims and equivalents thereof.

What is claimed is:

1. An integrated chassis assembly for an electric vehicle,
comprising a front vehicle frame (1), a battery pack housing (2), and a rear vehicle frame (3), wherein the front vehicle frame (1) and the rear vehicle frame (3) are respectively arranged at a front side and a rear side of the battery pack housing (2); a battery pack (4) is arranged in the battery pack housing (2); a whole-vehicle controller (6) is arranged on the battery pack housing (2); a motor-electric control integrated machine (9) is arranged on a rear side surface of the battery pack housing (2);
the whole-vehicle controller (6) is provided with a first electric plug (6-1), and a first electric socket (2-1) cooperated with the first electric plug (6-1) is arranged on the battery pack housing (2); the whole-vehicle controller (6) is in circuit connection with the battery pack (4) through cooperation of the first electric plug (6-1) and the first electric socket (2-1);
a heat dissipation assembly (10) is arranged on a front side surface of the battery pack housing (2), the heat dissipation assembly (10) is connected with an internal water passage (2-3) in the battery pack housing (2), and the internal water passage (2-3) passes through the battery pack (4);
the motor-electric control integrated machine (9) is provided with a second electric plug (9-2) and a water pipe connector (9-3), a second electric socket (2-2) cooperated with the second electric plug (9-2) is further arranged on the rear side surface of the battery pack housing (2), the motor-electric control integrated machine (9) is in circuit connection with the battery pack (4) and the whole-vehicle controller (6) through cooperation of the second electric plug (9-2) and the second electric socket (2-2), the water pipe connector (9-3) is connected with the internal water passage (2-3) in the battery pack housing (2), and the internal water passage (2-3) passes through the motor-electric control integrated machine (9); and
the battery pack (4), the whole-vehicle controller (6) and the motor-electric control integrated machine (9) are in circuit connection.

2. The integrated chassis assembly for the electric vehicle according to claim 1, wherein a charging seat (8) is arranged on a side surface of the rear vehicle frame (3), and the charging seat (8) is in circuit connection with the battery pack (4).

3. The integrated chassis assembly for the electric vehicle according to claim 2, wherein a cushion support (13) is further arranged on the rear vehicle frame (3), and the cushion support (13) and the rear vehicle frame (3) are locked and fixed through screws.

4. The integrated chassis assembly for the electric vehicle according to claim 2, wherein an antilock brake system (ABS) controller (5) is arranged on the front vehicle frame (1), the ABS controller (5) is installed on the front vehicle frame (1) through a support, and the ABS controller (5) is in circuit connection with the battery pack (4), the whole-vehicle controller (6), the charging seat (8) and the motor-electric control integrated machine (9).

5. The integrated chassis assembly for the electric vehicle according to claim 2, wherein a pedal support (11) is further arranged, and the pedal support (11) is installed at the position of a boss below the battery pack housing (2).

6. The integrated chassis assembly for the electric vehicle according to claim 2, wherein a side bracing (12) is further arranged, the side bracing (12) is locked to the side surface of the battery pack housing (2) through screws, and a power-off switch (7) is further integrated to the inner side of the side bracing (12); and the power-off switch (7) is in circuit connection with the battery pack (4), the whole-vehicle controller (6), the charging seat (8), and the motor-electric control integrated machine (9).

7. The integrated chassis assembly for the electric vehicle according to claim 1, wherein a heat dissipater (10-1), a refrigerator (10-2), and an electronic water pump (10-3) are arranged in the heat dissipation assembly (10).

8. The integrated chassis assembly for the electric vehicle according to claim 2, wherein the whole-vehicle controller (6), the charging seat (8), and the motor-electric control integrated machine (9) are all locked and fixed to the battery pack housing (2) through screws.

9. The integrated chassis assembly for the electric vehicle according to claim 1, wherein the front vehicle frame (1), the battery pack housing (2), and the rear vehicle frame (3) are made of lightweight aluminum alloy materials, and are formed in a manner of die casting and through adopting a liquid forging technology.
